(19) United States
(12) Patent Application Publication
(10) Pub. No.: US 2016/0092057 A1
(43) Pub. Date: Mar. 31, 2016

(54) E-READING DEVICE TO ENABLE INPUT ACTIONS FOR PANNING AND SNAPBACK VIEWING OF E-BOOKS

(71) Applicant: Kobo Inc., Toronto (CA)

(72) Inventors: Dae Hyuk Yoon, Toronto (CA); Jonathan Truong, Toronto (CA)

(21) Appl. No.: 14/502,023

(22) Filed: Sep. 30, 2014

(51) Int. Cl. G06F 3/0485; G06F 3/0484; G06F 3/0483

(52) U.S. Cl. CPC G06F 3/0485; G06F 3/0483; G06F 3/04842

(57) ABSTRACT

An e-reading device is operable to enable a user to pan a content segment (e.g., page or set of pages for a periodical). The user can specify a designated input action in order to enable the paying to be temporary, so as to automatically return that the e-reading device automatically returns to displaying the portion of the content segment that is marked as an origin or point of return.

### TECHNICAL FIELD

Examples described herein relate to an e-reading device, and more specifically, to an e-reading device that enables input actions for panning and snapback viewing of e-books.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

E-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system that utilizes an e-reading device for enabling panning and snapback viewing of e-books, according to an embodiment.

FIG. 2 illustrates an example of an e-reading device, for use with one or more embodiments described herein.

FIG. 3 illustrates an e-reading system in accordance with one or more embodiments.

FIG. 4 illustrates a method for enabling panning and snapback viewing of e-books, according to an embodiment.

FIG. 5A through FIG. 5C illustrate an example of an e-reading device for implementing a panning and snapback feature, according to one or more embodiments.

### DETAILED DESCRIPTION

Examples described herein provide for an e-reading device that provides functionality for enabling the user to temporarily pan a content segment of a content item, such as an electronic periodical, and then return to viewing the portion of the content segment that was had been viewed when panning was initiated. Among other benefits, examples such as described enable the user to pan a content segment and have the act of panning tethered to a point of return (e.g., point of origin from where panning was initiated on the content segment). Once the panning is deemed complete, the e-reading device automatically returns to displaying the portion of the content segment coinciding with the point of origin. The act of the e-reading device automatically returning to display the content portion from the point of origin (from which tethering was initiated) is termed a snapback.

In more detail, a user can select to pan different portions of a content segment. In particular, electronic reading offers numerous use cases in which the content segment being rendered is oversized as compared to the display area, font size and magnification employed. The oversizing of content can include special cases which format the content segments of the e-book in accordance with publisher preferences or requirements (e.g., electronic magazines or periodicals). In the case of electronic magazines and periodicals, for example, the content segments reflect can be displayed in a format or structure (e.g., image format) that precludes segmentation or page breaking. As a result, the pages of electronic magazines and other periodicals can sometimes appear enlarged relative to a size of the display screen for the e-book.

In some embodiments, the input actions for panning can be implemented in context of a designated event, so that when the panning is complete, the e-reading device returns to displaying a predetermined portion of the content segment. In one example, the e-reading device can return to display the portion of the content segment that was being displayed prior to panning having occurred (i.e., the point of origin).

Still further, examples described herein recognize that some types of e-books can be formatted to have a predetermined layout that is oversized as compared relative to the display area provided by a typical e-reading device. The formatting provided with such e-books can sometimes reflect publisher preference, carry contextual information, and/or simulate a physical version of the e-book. Often, such formats are provided in a structure and layout (e.g., as an image) which precludes page breaks for display fitting. Unless displayed in oversized format, the magnification reduction needed can make viewing the pages of the formatted e-book difficult to view.

In such cases, panning offers an alternative in that it enables the user to focus on portions of the content segment, and to move the focus in a directional manner as desired. However, examples described herein recognize that panning can disorient the reading experience of the user, particularly the ability of the user to track his or her location on a content segment (e.g., page or dual page set).

In some embodiments, an e-reading device is operable to enable a user to pan a content segment (e.g., page or set of pages for a periodical). The user can specify a designated input action in order to make the panning temporary and subject to a snapback, meaning the content displayed through the e-reading device is automatically returned to being the portion of the content segment that is marked as an origin or point of return.

By way of example, periodicals such as magazines, newspapers, comic books and journals, are often published as physical copies that have organization and arrangement of content items that reflect publishing preferences, particularly for characteristics such as context and/or appearance. In such publications, the content items that appear on a page (or alternatively on opposing pages that separate from one another by a binding or centerline) are often specifically selected as part of the organization and arrangement of that periodical. Moreover, publications sometimes rely on full size (e.g., “8.5×11”) or oversized paper. When such publications are published in electronic format, the screen size of the e-reading device is not usually sufficient to depict the entire page (or set of two pages) at one time under a default or standard setting, particularly since the electronic periodicals often carry images and fine text. For example, a page of a magazine often carries numerous rich images, as well as fonts of varying size (including small font). Magazine publishers often prefer to have electronic versions of the magazine reflect the layout, appearance and other formatting of the print version. While some content such as literary books can be reformatted for the e-reading device, re-formatting of e-books such as periodicals with predetermined layouts is less desirable, because the publisher layout and context would be lost. Moreover, the data structure of the periodical (e.g., image) can preclude graceful pagination. A display screen of an electronic device is often smaller than what is needed to display a page (or dual pages) of a magazine or other periodical with sufficient magnification. As a result, an e-reading device can only display a portion of a page at a time.

According to some embodiments, an e-reading device can be operated to display an e-book in accordance with a predetermined or specialized format. In particular, an e-reading device can be used to render an e-book which is formatted to have a predetermined layout in which individual segments are to be rendered continuously, in their respective entirety, so that the content items appear without page transition, page break or other segmentation. When an individual segment is rendered, the e-reading device may, under a predetermined or default setting, display only a portion of the segment at any one time while enabling a user to pan to another portion of the segment. When a first portion of the segment is rendered, a first input action of a particular type can be detected. In response to detecting the input action, the first portion is recorded as an origin of a pan event. One or more second input actions can be detected until the pan event is detected as being complete. The second input actions can be processed by panning to at least a second portion of the content segment based on position information determined by processing the individual second input actions. When the pan event is detected as being complete, an e-reading device can automatically pan back to the first portion that is recorded as the origin of the pan event.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

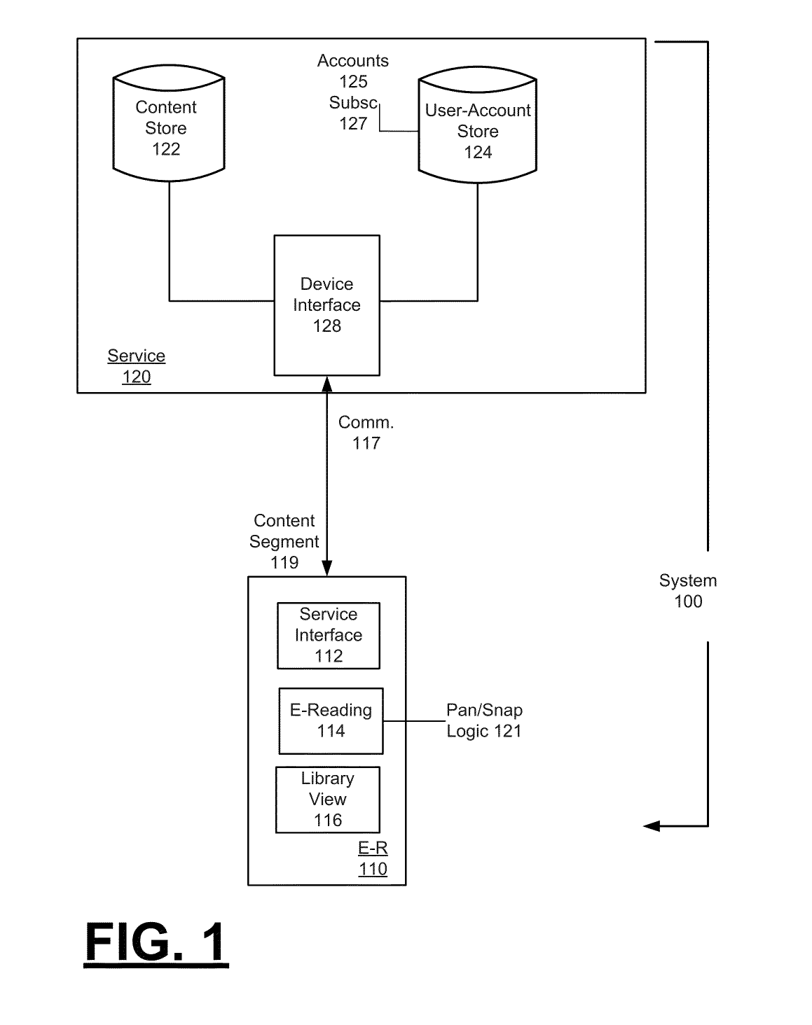

FIG. 1 illustrates a system that utilizes an e-reading device for enabling panning and snapback viewing of e-books, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-reading functionality provided on the e-reading device 110. The e-book services can enable e-books (including electronic magazines and other periodicals) to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books, including electronic magazines and other periodicals). For example, the e-reading device 110 can have a tablet like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The user account 125 can also include subscription data 127 for the user. The subscription data 127 can identify the subscriptions of periodicals that the user has purchased, or agreed to purchase. A given periodical can be identified by a title and by issues which are published periodically. The issues can individually be identified by volume, number, and/or by date. The periodical issues are examples of e-books which can be published with formatting characteristics that are predetermined, including formatting restrictions that require content items appearing on a page or opposing set of pages to remain contiguous and/or fixed in position relative to other content items.

The e-reading device 110 can include a service interface 112 and an e-reading component 114 and a library view component 116. The e-reading device 110 can execute the service interface 112 to receive resources and data from the network service 120. The service interface 112 can signal, to the network service 120, an identifier for the user and/or user account. The service interface 112 can interface with the network service 120 to receive resources such as applications and content items (e.g., e-books, music files, etc.) from the network service. Optionally, the e-reading device 110 can communicate with multiple services in order to receive resources. The resources that can be received can be responsive to user-input or action (e.g., purchasing input), or automated (e.g., automatic download of new issue of periodical based on user subscription data 127).

The e-reading device 110 can execute the e-reading component 114 to enable e-reading activities. In one aspect, the e-reading component 114 can render paginated content from e-books (e.g., electronically formatted literary works). Many e-books, such as literary works which are primarily text-based (e.g., novels) can be paginated on-the-fly by the e-reading component 114. The page structure and page number can be set by factors such as, for example, a display size of the device, a predetermined magnification setting, and/or font size setting of the device.

Still further, in another aspect, the e-reading device 110 can render pre-formatted e-book segments for e-books such as electronic periodicals. While such e-book segments are paginated, the e-reading component 114 can identify or otherwise recognize a predetermined layout for such e-books that restricts, for example, the pagination and spatial appearance of content item provided with the segment. By way of example, some e-books, such as magazines and other periodicals, are electronically published to simulate a print copy. The visuals of the print copy or replicated in electronic format. This includes, for example, the layout of the content items appearing on a page of a magazine, or alternatively, on opposing pages of the magazine. In some embodiments, the e-reading component 114 can execute in a default or user-specified mode in which the content items that are rendered for a segment (e.g., page or set of two pages) appear to have a relatively fixed size or ratio, with spatial relationships amongst the content items of the segment being set by the predetermined format. Likewise, other dimensional aspects of the content appearing in the segment can also be static, such as the font size or relative size of content items to one another. The restriction on spatial and dimensional variation can be implemented using, for example, a file format, such as an image format. For example, a single image can be used to display both text and image as a page of a magazine. In this manner, the structure and format of the periodical page preclude the e-reading component 114 from creating a lateral or vertical page break that is not otherwise specified with the predetermined format. Given the restrictions of the preformatted e-book, the e-reading component 114 can include programming or other logic to pan a segment of an e-book (e.g., magazine or other periodical). Additionally, in rendering such content segments to be pannable, the e-reading component 114 can execute to display only a portion of the pre-formatted segment, while other portions of the content segment are not immediately visible but viewable by panning.

The library view component 116 can include a user interface that provides a presentation of the content items (e.g., e-books, including magazines and periodicals) in a defined library. The library can include the user's entire collection of e-books, as well as e-books that are being promoted or otherwise displayed through metadata content on the user device. For example, a library can include e-books in a user collection and/or e-books that network service 120 is promoting and/or making available for purchase or download. The presentation of the content items can be based on metadata content associated with the individual content items. For example, in the case of e-books, the metadata content used to display representations of the e-books in the user library can include images provided by the publisher (e.g., icons or graphic objects) which represent or appear as a book cover or jacket. Likewise, in the case of music or movies, representations of the content items in the user's library can be based on icons or graphic objects that represent album art (music) or box cover art (movies).

The library view component 116 can generate presentation of e-books or other content items of the user's library using a variety of paradigms. For e-books in particular, the library view component 116 can display the metadata content of the e-books (e.g., icons representing book or magazine covers) in the form of lists, or on a virtual bookshelf that is personalized for the user library (e.g., a book shelf displaying portions of icons representing book covers, magazine covers and/or comic book covers which are in the user library).

In some embodiments, the e-reading component 114 can include pan and snap logic 121 for enabling a reader to pan portions of a content item with automated control for returning the viewing area to an original position. In one implementation, the content item can correspond to, for example, a preformatted content segment of the e-book, such as a magazine or other periodical. In variations, the content item can correspond to a webpage or other text content that can be spatially configured to enable panning. When the user pans, the user directionally shifts what the display screen displays on a given content segment. The act of panning can also be coupled to magnification. When the user provides input to initiate panning, magnification can be reduced to enable the user to view a larger portion of the content segment.

In examples where the content segment is preformatted and enlarged relative to the viewing area of the e-reading device 110, panning enables the user to focus viewing of the content segment, such as to enlarge text and/or images, and to directionally move the viewing area about the layout of the content segment in order to view desired sections of the content segment. While panning enables a user to view a portion of a content segment in detail and up close, panning can also disorient the user in terms of the relative position of the viewing area on the content segment as a whole.

Accordingly, the pan and snap logic 121 automates the act of returning the viewing area of the content segment to the specific portion of the content segment that was being displayed just prior to when the user initiated the panning event. Among other benefits, the pan and snap logic 121 enables the user to initiate a panning event in which another portion of the content segment is brought into focus on the display screen on a temporary basis. This allows for the user to view another portion of the content segment before the content displayed through the e-reading component is automatically returned to the point of origin.

In some embodiments, the magnification of the portion of the content segment that is subjected to the panning action can be automatically altered based on a user or default setting. For example, the e-reading device can implement demagnification of the content item with the act of initiating panning, so that the user can view more of the content segment before selecting the direction for panning. Likewise, then the user initiates panning, or pans to a specific location (e.g., the user pauses panning), magnification can be returned or increased. In this way, the pan and snap logic 121 can be implemented to both (i) return to the original viewing area that is identified as the point of origin, and (ii) return magnification level to that which existed before panning was initiated. Among other benefits, the e-reading device 110 can enable the user to pan about the content segment on a temporary basis, while automatically adjusting magnification to facilitate panning. Upon the occurrence of a trigger signifying the end of a panning event, the e-reading device 110 can snapback to displaying the point of origin at the original magnification.

Hardware Description

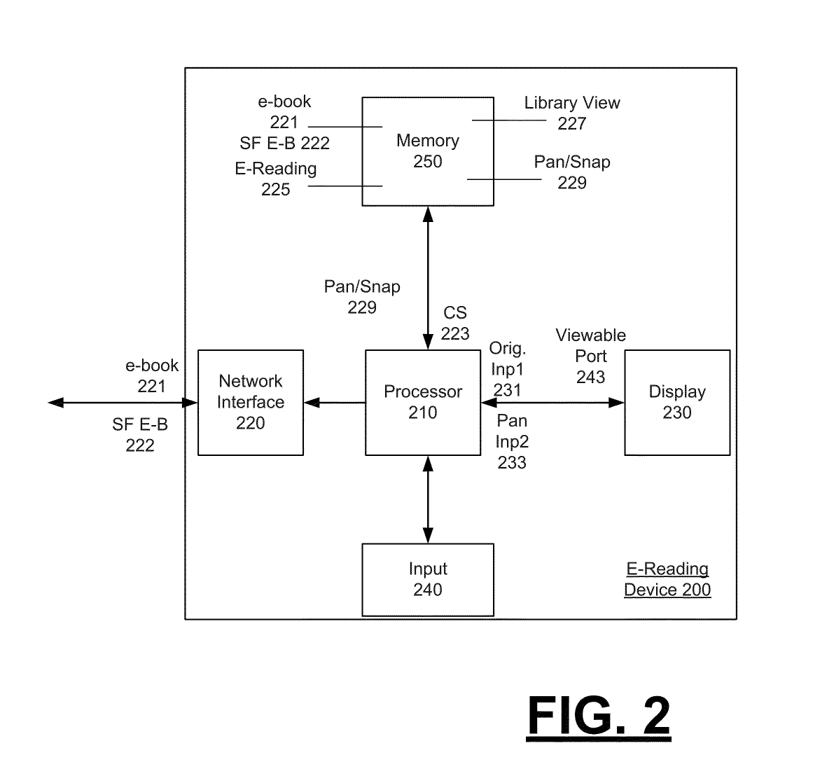

FIG. 2 illustrates an example of an e-reading device for use with one or more embodiments described herein. In an example of FIG. 2, an e-reading device 200 can correspond to, for example, a mobile computing device such as shown by an example of FIG. 1.

With reference to FIG. 2, e-reading device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“e-reading instructions 225”) for operating an e-reading application (e.g., see e-reading component 114 in FIG. 1). The memory 250 can also store library view instructions 227 for providing a library view component (e.g., see library view component 116 in FIG. 1).

Additionally, the processor 210 can execute a set of instructions for enabling panning and snapping back functionality (“pan/snap instructions 229”). In one implementation, the pan/snap instructions 229 execute as part of e-reading component 114 when the e-reading component displays a content segment. Alternatively, the pan/snap instructions 229 can execute as a module or plug-in of the e-reading component. Still further, the pan/snap instructions 229 can execute as an independent process. In some examples, the e-book being rendered is of a type or characteristic (e.g., data type, dimensional characteristics, etc.) for which preformatting is specified or preferred, resulting in a fixed and defined spatial relationship amongst content items appearing on a page or other segment of the e-book. For example, a pre-format can be designated or preferred for electronic magazines, based on a layout and format of the print version of the same magazine, so that the electronic magazine replicates the physical magazine. In such examples, the e-reading component 114 can render a segment of the e-book (e.g., single page or two adjacent pages of a magazine) by displaying a first portion 243 of the content segment while other portions of the content segment are viewable through panning.

According to one aspect, the processor executes the pan/snap instructions 229 to identify a pan event corresponding to the user providing a first input 231. The first input 231 can be detected through a first type of user interaction, provided with, for example, the display 230. By way of example, the first input 231 can correspond to the user providing a first touch input on a displays screen of the display 230. The first touch input can correspond to a touch and hold, or sustained touch.

Once the processor 210 detects the first input 231, a pan event can be initiated. During the pan event, the processor 210 can interpret a second type of input 233 as directional or positional. The second input 233 can be interpreted by the processor 210 to identify a different portion 243 of the content segment to display through the e-reading component 114.

The processor 210 can implement the pan/snap instructions 229 to detect a condition or event which ends the pan event. In one example, the pan event can be maintained for the duration of time in which the touch contact of the user is sustained on a display surface of the e-reading component 114. Once the panning event is detected as being completed, the e-reading component 114 can automatically return or snapback to displaying the point of origin.

Device System

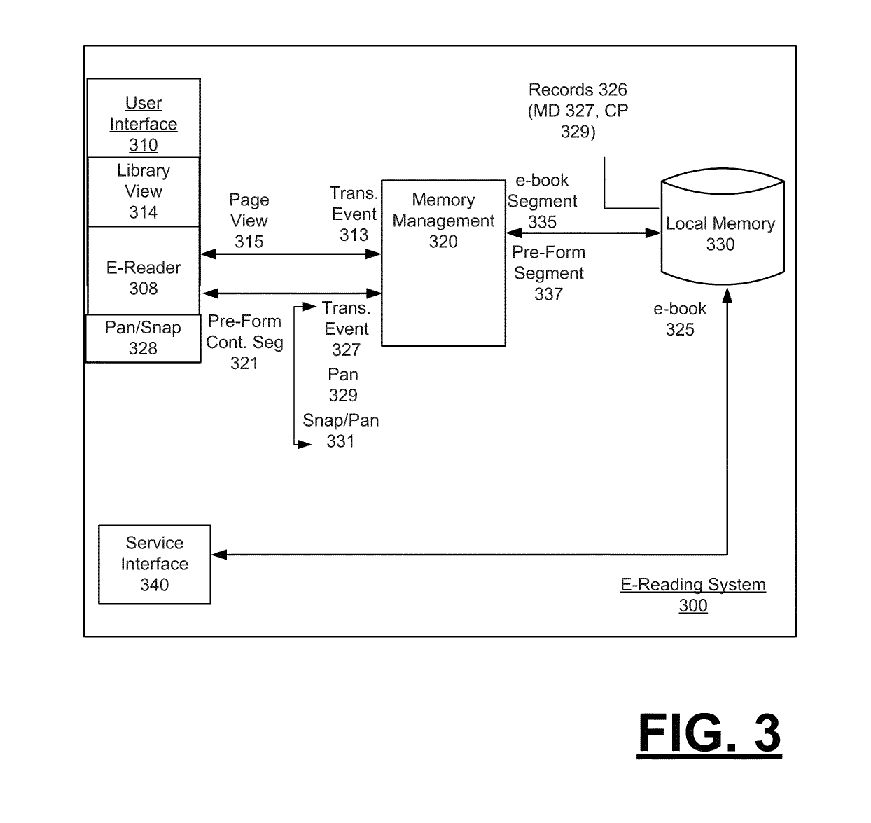

FIG. 3 illustrates an e-reading system in accordance with one or more embodiments. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels). The pagination of e-books can be determined on the fly by, for example, memory management module 320, based on user or device settings (e.g., font preferences, display size etc.). In such cases, the content of the e-book can be segmented to appear as individual pages are page sections, each of which occupy an entire display region which can be viewed by page transitions. For some e-books, however, a preferred or designated pagination may also exist which is static in terms of relative size and positioning of content items. For example, the e-book can have a data type or structure that precludes alternative pagination. As a result, the fonts of the text content may be maintained in relative portion to a predetermined aspect ratio or dimension of the page as a whole. Furthermore, spacing between content items (e.g., image and text column) may remain fixed, and a page or other content section may be rendered as a non-paginated item. Typically, e-books such as periodicals (e.g., magazines, comic books, journals, etc.) may be provided with such static or predetermined formats in order to simulate a physical format or layout, or an actual physical version of the same magazine.

In some variations, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-book system 300 includes an e-reading component 308 and a library view component 314. The e-reading component 308 can include functionality to render e-books that utilize both dynamically determined pagination and pre-formatted or static pagination. For e-books that are dynamically paginated, the e-reading component 308 (i) renders page views 315 from the particular e-book, and (ii) detect page transition events 313. The page views 315 can include the content portion 329 of the e-book being read (e.g., opened or rendered), and the content portion 329 can be dimensioned into page segments that fit in their entirety on the display screen of the e-reading device for system 300. For example, the e-reading component 308 can display a page view 315 from an e-book corresponding to a novel, and the page view may include text and/or image content. The page event 313 can correspond to, for example, a page turn, a chapter turn, or a clustered page turn.

In some embodiments, the e-reading component 308 also renders preformatted or statically configured content segments of e-books in which such pre-formatting is preferred, designated or otherwise enabled. The e-reading component 308 can receive a preformatted content segment 321, having statically arranged content items. The content segment 321 can be rendered through the e-reading component 308 as a single item that is devoid of page breaks. As such, when the content segment 321 is displayed at an appropriate magnification level, the content segment can appear oversized relative to the display area of the e-reading component 308. The e-reading component 308 can include functionality, including pan and snap logic 328, to enable the user to interact and view the content segment through panning.

In implementation, the e-reading component 308 can render preformatted content segment 321. For example, the memory management module 320 can retrieve preformatted content segments 321, corresponding to a page or dual set of pages for a periodical for rendering by the e-reading component 308. The user can interact with the e-reading component 308 to specify (i) a transition event 327, where one content segment is transitioned to another content segment (e.g., to simulate page flipping through a magazine); (ii) pan input 329 to trigger a pan event in which the user initiates panning, so that the display area provided to the e-reading component 308 displays content from different portions of the content segment based on directional and/or position information from the user; and (iii) pan and snap input 329 to enable the user to temporarily pan to different portions of the content segment, before the e-reading component 308 responsively returns the user to an original viewing area that was displayed prior to the pan and snap input 329 being received.

The pan and snap input 329 can be implemented as a combination of user actions, and more specifically, as a combination of continuous user actions, such as derived from a series of press touch and hold actions. By way of example, in one implementation, a user can touch and hold a display screen of an e-reading device for system 300, in order to trigger a pan and snap event. The touch area can correspond to, for example, a center region of the display area, or alternatively to any area of interest to the user. The initial touch can be held for time duration that exceeds a threshold, triggering the e-reading device of system 300 to recognize a pan and snap event. Subsequently, the user can move the point of contact (e.g., finger) directionally to indicate a position of direction of the panning, and the e-reading device then adjust the content of what is displayed to reflect the position of the point of contact. Once initial touch is lifted, the e-reading device of system 300 can recognize completion of the pan and snap event, and automatically return to displaying content from the original portion of the content segment before the pan and snap event was detected.

Still further, in some implementations, panning 327 and/or pan and snap input 329 can result in programmatic actions that automatically adjust magnification based on a stage of the panning event. For example, when the pan and snap event is first detected, the e-reading component 308 can implement magnification when displaying a current portion of the content segment, so as to display the content segments in more focus when panning is being performed.

The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

Methodology

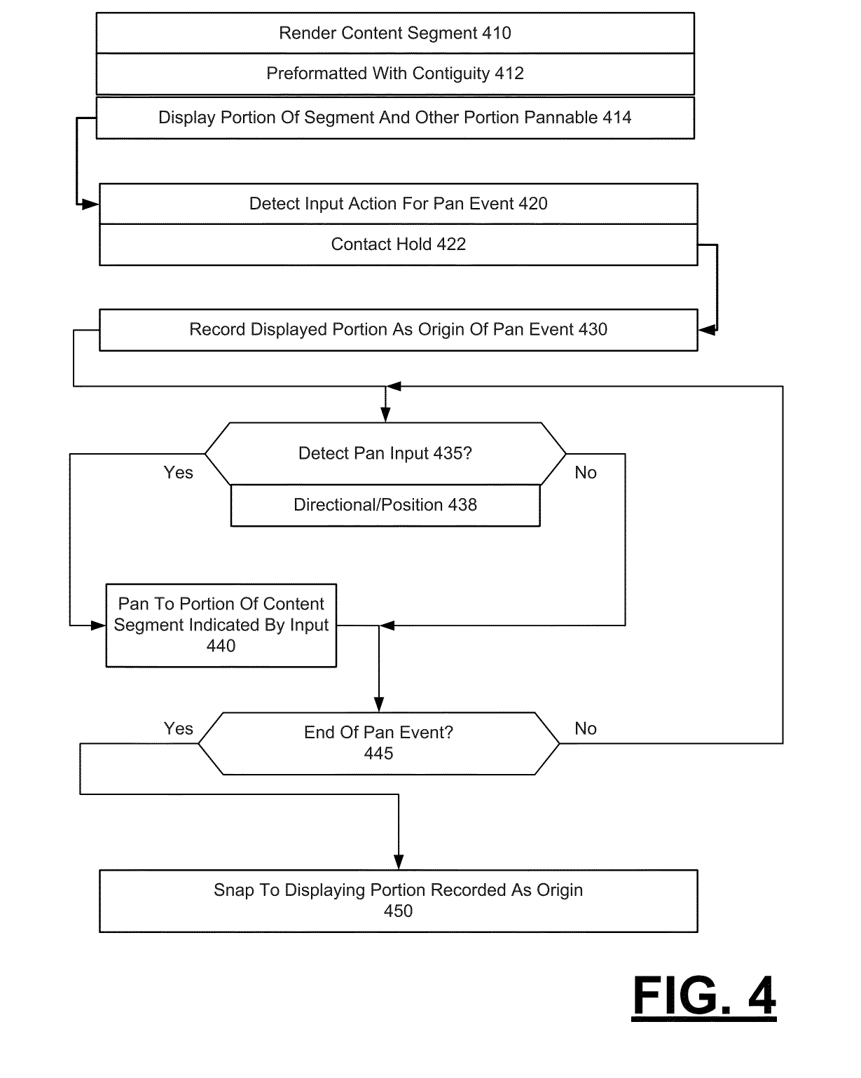

FIG. 4 illustrates a method for enabling panning and snapback viewing of e-books, according to an embodiment. An example such as described by FIG. 4 can be implemented using components such as described with FIG. 1, FIG. 2, or FIG. 3. Accordingly, reference may be made to elements of other figures for purpose of illustrating suitable elements or components for performing a step or sub-step being described.

With reference to FIG. 4, a content segment of an e-book is rendered (410). In the case of periodicals such as magazines, the content segment can correspond to a page, or a dual set of pages separated by a simulated binding or divider. The content segment can be preformatted so that much of the formatting and layout is static (412). For example, a data format of the content segments for the e-book can be of a static nature (e.g., image based). Still further, a relative size of content items to one another and to the segment as a whole can be fixed, as can the relative position of content items to one another. The content segment can also be rendered as a continuous item, without presence of page breaks. In this way, select portions of the content segment can be displayed when the content segment as a whole is being rendered (414). For example, a user can display a specific portion of a content segment, with other portions of the same content segment being out of view from the display area. The out of view portions of the content segment can be panned for viewing at the option of the user.

An e-reading device can detect an input action signifying a pan and snap event (420). By way of example, the user can detect a touch and hold input action of a user on a designated region of the display screen for the e-reading device (422). The touch and hold can exceed a time duration threshold before being interpreted to signify that pan and snap event is occurring.

When the pan and snap event is detected, the displayed portion of the content segment is recorded as the origin or point of return (430). A determination can then be made as to whether a pan input is detected (435). The determination can be based on directional and/or position input (438) provided by the user. By way of example, the directional and/or position input can be provided by the user maintaining continuous touch on the display screen while moving the point of contact in a direction of the desired portion of the content segment.

If pan input is detected, the e-reading component 308 pans to the portion of the content segment indicated by the input (440). If there is continuous input, the panning may follow the input in a continuous fashion. If pan input is not detected (following (425)), or if panning for the prior input is complete (following 440), then a determination is made as to whether the pan event is over (445). For example the termination of the pan event can be signified by the continuous touch input being terminated (e.g., user lifts finger off of screen). If the pan input is not complete, a return can be made to (435), where a determination is made as to whether additional pan input is detected. Else, if the end of the pan event is determined to occur, then the e-reading component 308 snaps back to displaying the portion of the content segment that is recorded as the region or point of return (450). This can be done automatically, when, for example, the user lifts his finger off the display screen.

### Examples

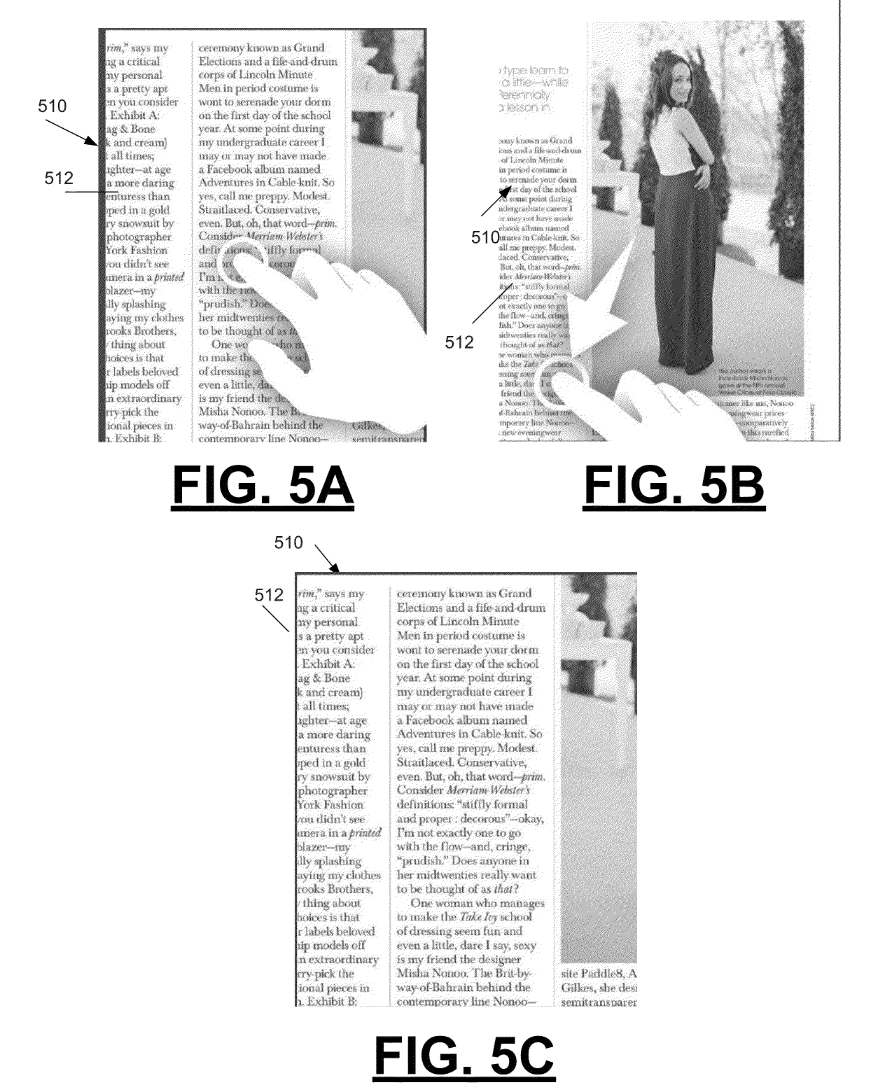

FIG. 5A through FIG. 5C illustrate an example of an e-reading device implementing a panning and snapback feature, according to one or more embodiments. An example of FIG. 5A through FIG. 5C can be implemented using, for example, an e-reading device such as described with FIG. 1 or FIG. 2, or using an e-reading system such as described with an example of FIG. 3.

With reference to FIG. 5A, an e-reading device 500 includes a display screen 510 that displays content 512 from, for example, the magazine page. The content can include text and/or image. The content segment can be preformatted and relatively static, in that the text and/or image are positioned to be fixed relative to one another, and the entire segment is rendered without page break separation. By way of example, the content segment can simulate a physical version of the magazine. A user can provide a designated input action, corresponding to a touch and hold in a designated region (e.g., middle of the display screen) of the display screen. Once the designated input action is detected by the e-reading device 500, a pan and snap event may be initiated. In one implementation, when the pan and snap event is detected, a demagnification is performed to enable the user to better view and pan the content segment.

In FIG. 5B, the user moves his finger directionally while maintaining content with the display screen. In implementing the pan and snap event, the e-reading device 500 monitors the position of the user's finger to identify a location to pan to. FIG. 5B illustrates that once the location is identified, the e-reading device 500 pans to the identified location.

FIG. 5C illustrates that upon completion of the pan and snap event (e.g., user lifts finger off the display screen), the e-reading component returns to displaying the portion of the content segment corresponding to the origin or point of return. In some variations, magnification is performed to return the viewing state to the original level of magnification (e.g., prior to the pan snap event being detected).

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
rendering a segment of an e-book, the segment of the e-book having a predetermined and fixed layout, so that rendering the segment includes displaying, under a given magnification setting, only a portion of the segment at any one time while enabling a user to pan to another portion of the segment;
detecting a first input action of a particular type when a first portion of the segment is rendered;
in response to detecting the input action, recording the first portion as a point of origin from which a pan event is initiated;
processing one or more second input actions until completion of the pan event, wherein processing the one or more second input actions includes panning to at least a second portion of the segment based on position information determined by processing the one or more second input actions;
detecting completion of the pan event; and
in response to detecting completion of the pan event, automatically returning to displaying the first portion of the content segment.

2. The method of claim 1, wherein rendering the segment includes rendering a predetermined layout of text and images at a predetermined magnification level.

3. The method of claim 1, wherein detecting the first input action includes detecting a touch and hold of the user on a surface of the computing device.

4. The method of claim 3, wherein detecting completion of the pan event includes detecting the user removing contact from the surface of the computing device.

5. The method of claim 3, wherein processing the one or more second input actions includes detecting a second touch on the surface of the computing device, the second touch indicating a position or direction for panning.

6. The method of claim 5, wherein processing the one or more second input actions includes displaying a second portion of the segment in place of the first segment based on the position or direction indicated by the second touch.

7. The method of claim 1, wherein each of detecting the first input action and processing the one or more second input actions includes detecting user contact with a display screen of the computing device.

8. The method of claim 1, wherein the e-book corresponds to an electronic periodical, and where in the layout simulates a print version of the electronic periodical.

9. A computing device comprising:
a housing including a display assembly and a display screen;
one or more sensors to detect user contact with the housing;
one or more processors provided within the housing, the processor operating to:
render a segment of an e-book, the segment of the e-book having a predetermined and fixed layout, so that rendering the segment includes displaying, under a given magnification setting, only a portion of the segment at any one time while enabling a user to pan to another portion of the segment;
detect a first input action of a particular type when a first portion of the segment is rendered;
in response to detecting the input action, record the first portion as an origin of a pan event;
process one or more second input actions until completion of the pan event, the processing including panning to at least a second portion of the segment based on position information determined by processing the one or more second input actions;
detect completion of the pan event; and
respond to detecting completion of the pan event by automatically returning to displaying the first portion of the content segment.

10. The computing device of claim 9, wherein the one or more processors render the segment by rendering a predetermined layout of text and images at a predetermined magnification level.

11. The computing device of claim 9, wherein the one or more processors detect the first input action by using the one or more sensors to detect a touch and hold of the user on a surface of the computing device.

12. The computing device of claim 11, wherein the one or more processors detect completion of the pan event by using the one or more sensors to detect the user removing the touch from the surface of the computing device.

13. The computing device of claim 11, wherein the one or more processors process the one or more second input actions by detecting a second touch on the surface of the computing device, the second touch indicating a position or direction for panning.

14. The computing device of claim 13, wherein the one or more processors process the one or more second input actions by displaying a second portion of the segment in place of the first segment, the second portion being based on the position or direction indicated by the second touch.

15. The computing device of claim 9, wherein the one or more sensors are integrated with the display screen to detect a user contact with the display screen, and wherein the one or more processors use the one or more sensors to detect each of the first input action and the one or more second input actions corresponding to user contact with the display screen of the computing device.

16. The computing device of claim 9, wherein the e-book corresponds to an electronic periodical, and where in the layout is determined by a print version of the electronic periodical.

17. A non-transitory computer-readable medium that stores instructions, that when executed by one or more processors, cause the one or more processors to perform operations that include:
rendering a segment of an e-book, the segment of the e-book having a predetermined and fixed layout, so that rendering the segment includes displaying, under a given magnification setting, only a portion of the segment at any one time while enabling a user to pan to another portion of the segment;
detecting a first input action of a particular type when a first portion of the segment is rendered;
in response to detecting the input action, recording the first portion as an origin of a pan event;
processing one or more second input actions until completion of the pan event, wherein processing the one or more second input actions includes panning to at least a second portion of the segment based on position information determined by processing the one or more second input actions;
detecting completion of the pan event; and
in response to detecting completion of the pan event, automatically returning to displaying the first portion of the content segment.

18. The non-transitory computer-readable medium of claim 17, wherein rendering the segment includes rendering a predetermined layout of text and images at a predetermined magnification level.

19. The non-transitory computer-readable medium of claim 17, wherein detecting the first input action includes detecting a touch and hold of the user on a surface of the computing device.

20. The non-transitory computer-readable medium of claim 19, wherein detecting completion of the pan event includes detecting the user removing the touch from the surface of the computing device.
